(19) United States
(12) Patent Application Publication
(10) Pub. No.: US 2025/0221882 A1
(43) Pub. Date: Jul. 10, 2025

(54) Neck and Shoulder Massager

(71) Applicant: Xiamen Emoka Health Science & Technology Co., Ltd., Xiamen (CN)

(72) Inventor: Guanghua Zhou, Xiamen (CN)

(21) Appl. No.: 18/430,739

(22) Filed: Feb. 2, 2024

(30) Foreign Application Priority Data
Jan. 4, 2024 (CN) 202410012774.X

(51) Int. Cl. A61H 7/00

(52) U.S. Cl. CPC A61H 7/007; A61H 2201/0107; A61H 2201/1215; A61H 2201/1611; A61H 2201/1616

(57) ABSTRACT

Disclosed is a neck and shoulder massager, which includes a housing, a machine core box, a driving assembly, a push rod, a mounting seat, a massage head and two shoulder straps. According to the present disclosure, the driving assembly is arranged in the housing, the massage head is mounted to the mounting seat protruding from the housing, and the push rod also protrudes from the housing. Since the massage head and the push rod are both exposed out of the housing of the massager, the massager can directly make contact with the human body for massaging the shoulders and the neck without being sleeved with a leather cover, so that the massager fits the human body more closely and has a good massage effect.

### CROSS-REFERENCE TO RELATED APPLICATION

The present application claims priority from Chinese Patent Application No. 202410012774.X filed on Jan. 4, 2024, the contents of which are incorporated herein by reference in their entirety.

### TECHNICAL FIELD

The present disclosure relates to the field of massagers, in particular to a neck and shoulder massager.

### BACKGROUND

At present, a series of massage and kneading equipment on the market bring convenience to people's work and life, and can effectively alleviate the symptoms of fatigue in cervical spine, spine, lumbar spine and other parts in work and life.

An existing neck and shoulder massager having a kneading function is usually provided with a shiatsu massage group and a kneading massage group, and the shiatsu massage group and the kneading massage group are respectively driven by corresponding driving mechanisms, so that the overall size of the massager is larger, the production cost is also increased, and the market competitiveness is not strong.

At the same time, the existing massager can only be used after the massage machine core is covered with a cloth cover. When the cloth cover is stained during use, the cloth cover needs to be completely removed, so that the cleaning is inconvenient, and the replacement cost is high. When the massage head needs to be replaced, the cloth cover needs to be removed before the massage head can be replaced. Moreover, the massage head and the massage seat of the massage machine core are integrated, and the massage seat needs to be replaced together when replacing the massage head. Therefore, it is necessary to disassemble the massage machine core and replace the massage head together with the massage seat, so that not only the replacement is inconvenient, but also the replacement cost is high.

In view of this, the designer deeply conceives and actively studies and improves the trial operation to develop and design the present disclosure in view of many defects and inconveniences caused by the imperfect structural design of the above massager.

### SUMMARY

An object of the present disclosure is to provide a neck and shoulder massager, which reduces the cost, is convenient to use, and improves the consumer experience.

To achieve the above object, the solution of the present disclosure is:
a neck and shoulder massager includes a housing, a machine core box, a driving assembly, a push rod, a mounting seat, a massage head, and two shoulder straps, wherein
the push rod is connected to the driving assembly and the housing and is limited by the housing, and the push rod partially protrudes from the housing and swings up and down;
the mounting seat is connected to the driving assembly and penetrates through the housing, and
the massage head is detachably mounted to the mounting seat, and rotatably swings with the mounting seat;
the driving assembly is mounted to the machine core box, and drives the push rod and the massage head to act;
the machine core box is arranged in the housing;
the two shoulder straps are detachably mounted to two sides of the housing, respectively, and the shoulder strap is formed by a hot pressing process.

Further, the housing includes an upper cover, a middle cover and a lower cover, wherein the upper cover and the lower cover are detachably mounted together, the middle cover is arranged in a space defined by the upper cover and the lower cover, the driving assembly is mounted on the middle cover, one end of the mounting seat is connected with the driving assembly, the other end of the mounting seat extends to the upper cover and is detachably connected with the massage head, one end of the push rod is connected with the driving assembly, and the other end of the push rod protrudes from the upper cover.

Further, the upper cover is provided with a first buffer sleeve corresponding to the mounting seat, and the first buffer sleeve sleeves the mounting seat; the upper cover is provided with a second buffer sleeve corresponding to the push rod, and the second buffer sleeve sleeves the push rod.

Further, the two shoulder straps are respectively covered with mounting sheets at the sides close to the housing, and the two shoulder straps are fixedly connected to two sides of the housing by the mounting sheets.

Further, the massage head includes a massage sleeve, a fixing piece and a base, wherein the base is detachably mounted to the mounting seat, the fixing piece is mounted to the base, and the massage sleeve sleeves the fixing piece.

Further, the massage sleeve is a hollow hemispherical soft rubber sleeve, the fixing piece is a hollow seat, and a cavity is defined by the massage sleeve, the fixing piece and the base.

Further, the lower cover and the middle cover are detachably connected by means of mutually matched male buckles and buckle holes.

Further, the driving assembly includes a center plate, a battery, a motor, a worm wheel, a transmission gear, a kneading shaft, a gland, an eccentric swing wheel, a kneading swing arm and a blocking piece, wherein the battery and the motor are both connected to the center plate, the motor is provided with a worm, and the worm is perpendicular to the kneading shaft;
the worm wheel and the transmission gear are coaxially mounted to the housing through an iron shaft, the middle of the kneading shaft is provided with a driven gear, the iron shaft is parallel to the kneading shaft, the driven gear is engaged with the transmission gear, and the worm wheel is engaged with the worm;
two glands are arranged on the kneading shaft by fixed transition connection with the eccentric swing wheels, two push rods are correspondingly arranged on one sides of the two eccentric swing wheels and are fixed and radially limited by the glands, and two kneading swing arms are correspondingly arranged on the other sides of the two eccentric swing wheels and are fixed and radially limited by the blocking pieces;
the gland is provided with a first shaft hole corresponding to the kneading shaft, and the kneading shaft passes through the first shaft hole; a side of the gland facing the push rod is provided with a connecting piece extending to the eccentric swing wheel;
the eccentric swing wheel is provided with a connecting groove corresponding to the connecting piece, a side of the eccentric swing wheel close to the gland is provided with an eccentric shaft, and the eccentric shaft is sleeved with the connecting hole; a side of the eccentric swing wheel close to the kneading swing arm is provided with an eccentric swing inclined plane and an eccentric swing shaft, the eccentric swing inclined plane is arranged between the eccentric shaft and the eccentric swing shaft; the eccentric swing wheel is provided with a second shaft hole corresponding to the first shaft hole, the second shaft hole and the eccentric shaft are eccentric, and the kneading shaft passes through the first shaft hole and is mounted inside the second shaft hole;
the push rod includes a connecting hole and a swing arm, the connecting hole sleeves the eccentric shaft at one end of the eccentric swing wheel, and a top end of the swing arm penetrates through the housing;
the mounting seat is formed at the top of the kneading swing arm, the kneading swing arm is provided with a through hole corresponding to the eccentric swing shaft, the through hole sleeves the eccentric swing shaft, and the kneading swing arm is obliquely arranged relative to the kneading shaft.

Further, the machine core box includes a box upper cover and a box lower cover, wherein the iron shaft and the motor are both mounted to the box lower cover, one end of the worm is connected to the motor, and the other end of the worm is fixed to the box lower cover; the box upper cover covers the kneading shaft and is mounted to the box lower cover, and the box lower cover is mounted to the housing.

Further, the neck and shoulder massager further include a guide groove, wherein the guide groove is detachably mounted to the housing, the bottom of the kneading swing arm is provided with a guide block, and the guide block is arranged in the guide groove in a clearance fit manner.

After the above solution is adopted, according to the present disclosure, the driving assembly is arranged in the housing, the massage head is mounted to the mounting seat protruding from the housing, and the push rod also protrudes from the housing. Since the massage head and the push rod are both exposed out of the housing of the massager, the massager can directly make contact with the human body for massaging the shoulders and the neck without being sleeved with a leather cover, so that the massager fits the human body more closely and has a good massage effect.

Meanwhile, the present disclosure adopts the design of the detachable massage head, so that the dirty massage head can be detached and cleaned independently, and compared with detaching and replacing the cleaning cloth cover, only the surface of the housing needs to be wiped, which is convenient for users to use; after the massage head is damaged, the whole machine does not need to be replaced, only the damaged massage head needs to be replaced, so that the replacement cost of users and the after-sales cost of merchants are lower; different massage heads may also be replaced according to the needs of different massage parts, which further improves the massage effect and the consumer experience while providing convenience for use.

Meanwhile, by combining the hot-pressing leather sleeve process with the neck and shoulder massager, the present disclosure optimizes the production process of the shoulder strap, improves the durability of the shoulder strap, and also makes the whole massager more aesthetically pleasing; since the two shoulder straps are detachably mounted to the housing, respectively, so that not only are the shoulder straps convenient to separately disassemble but also the replacement cost is reduced.

### BRIEF DESCRIPTION OF FIGURES

To illustrate the technical solutions in the embodiments of the present disclosure or the prior art more clearly, the accompanying drawings required to be used in the description of the embodiments or the prior art will be briefly described below, and it is obvious that the accompanying drawings in the description below are only some embodiments of the present disclosure, and other drawings may be obtained according to these drawings for those of ordinary skill in the art without paying inventive step.

FIG. 1 is a structural exploded view of a preferred embodiment of the present disclosure;

FIG. 2 is a structural schematic diagram of a preferred embodiment of the present disclosure;

FIG. 3 is a structural schematic diagram of a preferred embodiment of the present disclosure without a lower cover;

FIG. 4 is a structural schematic diagram of a gland according to a preferred embodiment of the present disclosure;

FIG. 5 is a structural schematic diagram of an eccentric swing wheel according to a preferred embodiment of the present disclosure;

FIG. 6 is a structural schematic diagram of a kneading swing arm according to a preferred embodiment of the present disclosure;

FIG. 7 is a structural schematic diagram of a push rod according to a preferred embodiment of the present disclosure; and

FIG. 8 is a structural schematic diagram of two shoulder straps according to a preferred embodiment of the present disclosure.

In the figures: 1, housing; 11, upper cover; 111, first buffer sleeve; 112, second buffer sleeve; 113, silicone pressing sheet; 12, middle cover; 121, guide groove; 122, fixing seat; 123, buckle hole; 124, buckling groove; 125, positioning seat; 13, lower cover; 131, male buckle; 132, buckling plate; 14, decorative piece; 2, driving assembly; 21, center plate; 22, battery; 231, motor; 232, worm; 241, worm wheel; 242, transmission gear; 243, iron shaft; 251, kneading shaft; 252, driven gear; 26, gland; 261, connecting piece; 262, first shaft hole; 263, fixing groove; 264, baffle; 265, first oil storage hole; 27, eccentric swing wheel; 271, eccentric shaft; 272, eccentric swing inclined plane; 273, eccentric swing shaft; 274, second shaft hole; 275, second oil storage hole; 276, connecting seat; 277, connecting groove; 278, fixing post; 279, third shaft hole; 28, kneading swing arm; 281, mounting seat; 282, through hole; 283, guide block; 284, second countersink; 285, second oil storage groove; 29, blocking piece; 3, push rod; 31, connecting hole; 311, first countersink; 312, first oil storage groove; 32, pivot hole; 33, swing arm; 4, massage head; 41, massage sleeve; 42, fixing piece; 43, base; 51, push rod pulling sheet; 52, positioning post; 53, push rod rotating shaft; 61, box upper cover; 62, box lower cover; 71, fixing ring; 72, bearing; 8, shoulder strap; 81, mounting sheet; 9, battery pressing sheet.

### DETAILED DESCRIPTION

In order to make the objects, technical solutions and advantages of the present disclosure clearer, the technical solutions of the present disclosure will be described in detail below.

In the description of the present disclosure, it needs to be understood that, the terms “central”, “longitudinal”, “lateral”, “upper”, “lower”, “front”, “rear”, “left”, “right”, “vertical”, “horizontal”, “top”, “bottom”, “inner”, “outer” and the like indicate an orientation or positional relationship based on that shown in the drawings, which is only for ease of description of the present disclosure and for simplicity of description, and not intended to indicate or imply that the device or element referred to must have a particular orientation, be constructed and operate in a particular orientation, and therefore should not be construed as limiting the present disclosure. In the description of the present disclosure, unless otherwise specified, the meaning of “plurality of” is two or more.

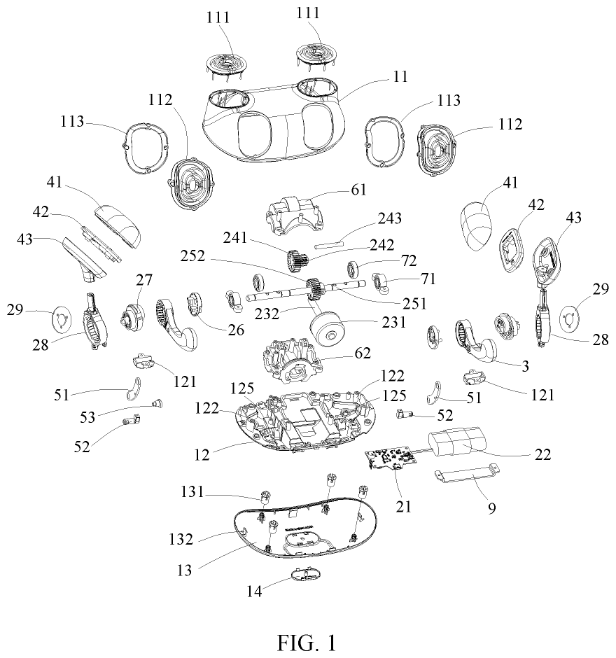

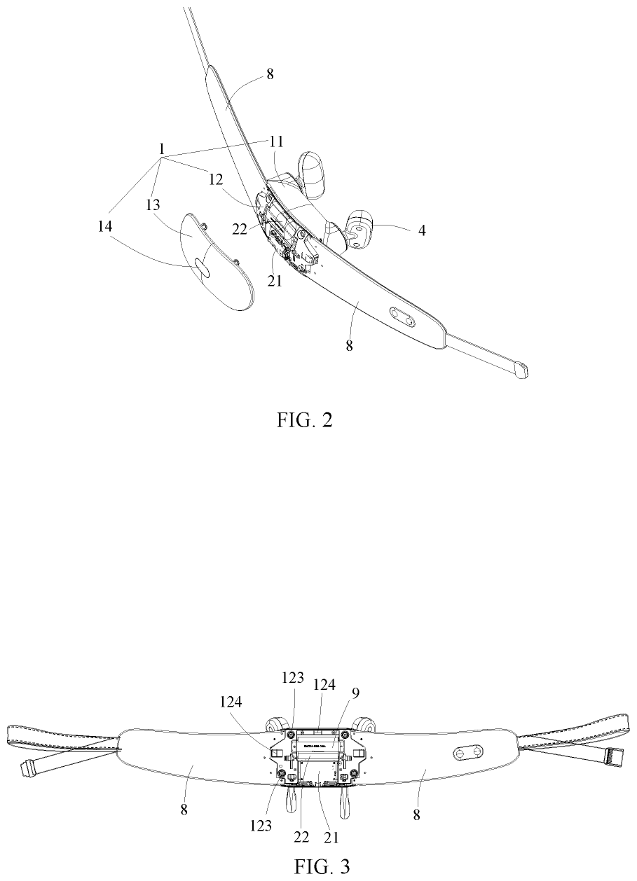

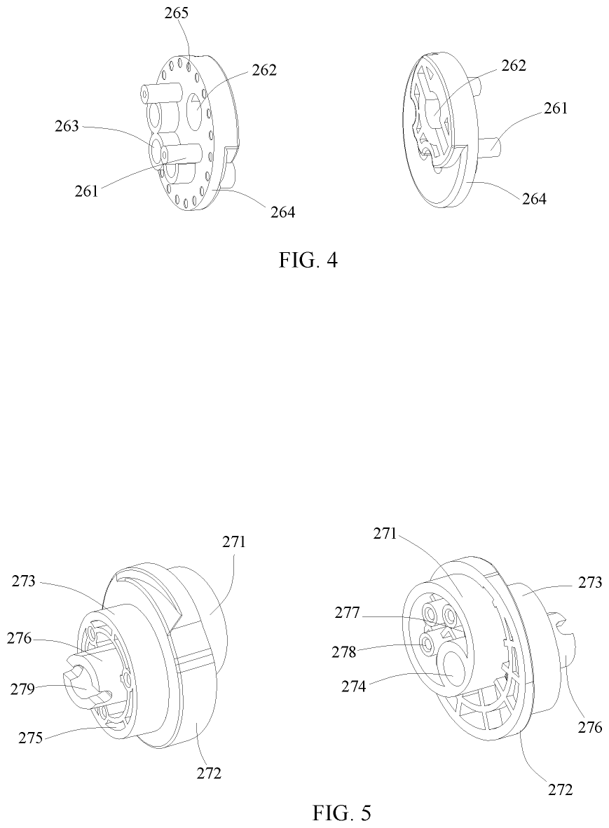

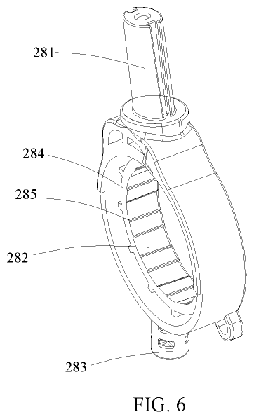

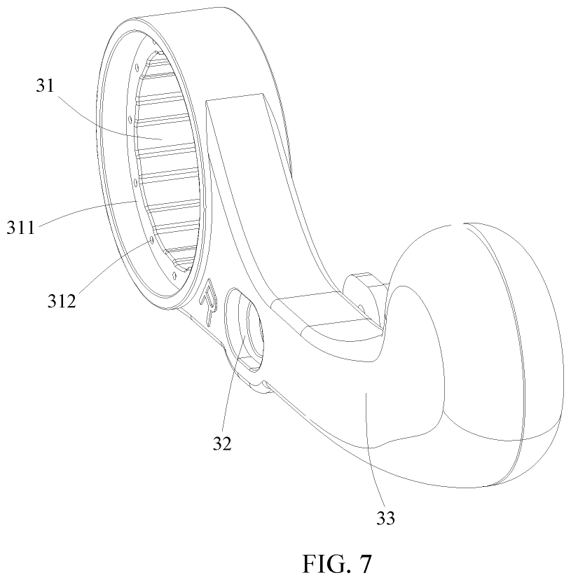

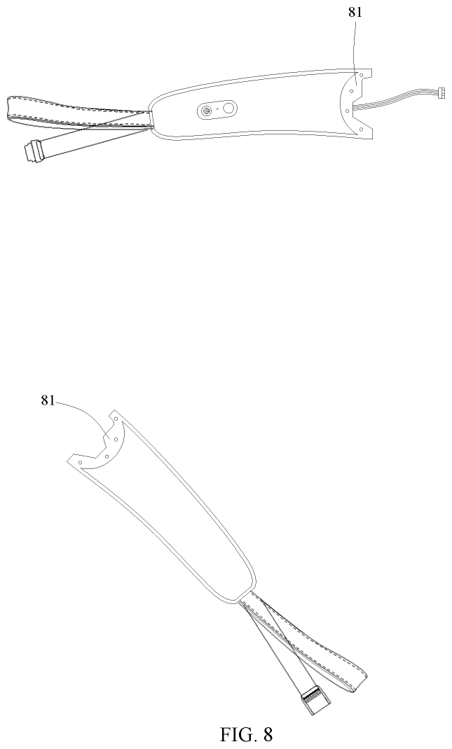

As shown in FIGS. 1 to 8, a preferred embodiment of a neck and shoulder massager of the present disclosure includes a housing 1, a machine core box, a driving assembly 2, push rods 3, mounting seats 281, massage heads 4, and two shoulder straps 8, wherein the push rod 3 is connected to the driving assembly 2 and the housing 1 and is limited by the housing 1, and the push rod 3 partially protrudes from the housing 1 and swings up and down; the mounting seat 281 is connected to the driving assembly 2 and penetrates through the housing 1, and the massage head 4 is detachably mounted to the mounting seat 281, and rotatably swings with the mounting seat 281; the driving assembly 2 is mounted to the machine core box and drives the push rods 3 and the massage heads 4 to act, and the machine core box is arranged in the housing 1; the two shoulder straps 8 are detachably mounted to two sides of the housing 1.

Specifically, the shoulder strap 8 is made by a hot pressing process, and the shoulder strap 8 is filled with sponge products. Compared with the process of sewing and edge sealing, the shoulder strap 8 is less prone to crack by using the leather sleeve process of hot pressing on both sides; the occurrence of cut surfaces on the peripheral side of the shoulder strap 8 is also avoided, so that the shoulder strap is more aesthetically pleasing.

By combining the hot-pressing leather sleeve process with the neck and shoulder massager, the present disclosure optimizes the production process of the shoulder strap 8, improves the durability of the shoulder strap 8, and also makes the whole massager more aesthetically pleasing; since the two shoulder straps 8 are detachably mounted to the housing 1, respectively, so that not only are the shoulder straps convenient to separately disassemble but also the replacement cost is reduced.

Meanwhile, according to the massager of the present disclosure, the driving assembly 2 is arranged in the housing 1, the massage head 4 is mounted to the mounting seat 281 protruding from the housing 1, and the push rod 3 also protrudes from the housing 1. Since the massage heads 4 and the push rods 3 are both exposed out of the housing 1 of the massager, the massager can directly make contact with the human body for massaging the shoulders and the neck without being sleeved with a leather cover, so that the massager fits the human body more closely and has a good massage effect.

Meanwhile, the present disclosure adopts the design of the detachable massage head 4, so that the dirty massage head 4 can be detached and cleaned independently, and compared with detaching and replacing the cleaning cloth cover, only the surface of the housing 1 needs to be wiped, which is convenient for users to use; after the massage head 4 is damaged, the whole machine does not need to be replaced, only the damaged massage head 4 needs to be replaced, so that the replacement cost of users and the after-sales cost of merchants are lower; different massage heads 4 may also be replaced according to the needs of different massage parts, which further improves the massage effect and the consumer experience while providing convenience for use.

Specifically, the driving assembly 2 includes a center plate 21, a battery 22, a motor 231, a worm wheel 241, a transmission gear 242, a kneading shaft 251, glands 26, eccentric swing wheels 27, kneading swing arms 28 and blocking pieces 29, wherein the battery 22 and the motor 231 are both connected to the center plate 21, the motor 231 is provided with a worm 232, and the worm 232 is perpendicular to the kneading shaft 251; the worm wheel 241 and the transmission gear 242 are coaxially mounted to the housing 1 through an iron shaft 243, the middle of the kneading shaft 251 is provided with a driven gear 252, the iron shaft 243 is parallel to the kneading shaft 251, the driven gear 252 is engaged with the transmission gear 242, and the worm wheel 241 is engaged with the worm 232;
the two glands 26 are arranged on the two ends of the kneading shaft 251 by fixed transition connection with the eccentric swing wheels 27, the two push rods 3 are correspondingly arranged on the outer sides of the two glands 26 and are fixed and radially limited by the glands 26, the two eccentric swing wheels 27 are correspondingly arranged on the outer sides of the two push rods 3, and the two kneading swing arms 28 are correspondingly arranged on the outer sides of the two eccentric swing wheels 27 and are fixed and radially limited by the blocking pieces 29;
the gland 26 is provided with a first shaft hole 262 corresponding to the kneading shaft 251, and the kneading shaft 251 passes through the first shaft hole 262; the side of the gland 26 facing the push rod 3 is provided with connecting pieces 261 extending to the eccentric swing wheel 27, the connecting piece 261 and the first shaft hole 262 are eccentric; the push rod 3 includes a connecting hole 31 and a swing arm 33, wherein the connecting hole 31 sleeves an eccentric shaft 271 at one end of the eccentric swing wheel 27, and the top end of the swing arm 33 penetrates through the housing 1; the blocking piece 29 is mounted to the eccentric swing wheel 27 and is arranged in the through hole 282 in a covering manner;
the eccentric swing wheel 27 is provided with a connecting groove 277 corresponding to the connecting piece 261, the side of the eccentric swing wheel 27 close to the gland 26 is provided with the eccentric shaft 271, and the eccentric shaft 271 is sleeved with the connecting hole 31; the side of the eccentric swing wheel 27 close to the kneading swing arm 28 is provided with an eccentric swing inclined plane 272 and an eccentric swing shaft 273, the eccentric swing inclined plane 272 is arranged between the eccentric shaft 271 and the eccentric swing shaft 273, and the eccentric swing shaft 273 is obliquely arranged with respect to the eccentric shaft 271; the eccentric swing wheel 27 is provided with a second shaft hole 274 corresponding to the first shaft hole 262, the second shaft hole 274 and the eccentric shaft 271 are eccentric, and the kneading shaft 251 passes through the first shaft hole 262 and is mounted inside the second shaft hole 274; the mounting seat 281 is formed at the top of the kneading swing arm 28, the kneading swing arm 28 is provided with a through hole 282 corresponding to the eccentric swing shaft 273, the through hole 282 sleeves the eccentric swing shaft 273, and the kneading swing arm 28 is obliquely arranged with respect to the kneading shaft 251.

In this embodiment, the eccentric swing wheel 27 is provided with a connecting seat 276 extending to the blocking piece 29, and the blocking piece 29 sleeves the connecting seat 276.

In order to further reinforce the connection between the gland 26 and the eccentric swing wheel 27, the side of the gland 26 facing the eccentric swing wheel 27 is provided with a fixing groove 263; the eccentric swing wheel 27 is provided with a fixing post 278 corresponding to the fixing groove 263 and extending to the gland 26, and the fixing post 278 is arranged in the fixing groove 263 of the gland 26 in a fit manner.

In this embodiment, two connecting pieces 261 are arranged on two sides of the first shaft hole 262, respectively, and two connecting grooves 277 are arranged on two sides of the second shaft hole 274, respectively; three fixing grooves 263 and three fixing posts 278 are arranged at intervals on the gland 26 and the eccentric swing wheel 27, respectively.

Specifically, the connecting piece 261 and the fixing groove 263 may also be arranged on the eccentric swing wheel 27, and the corresponding connecting groove 277 and fixing post 278 may be arranged on the gland 26.

The massager of the present disclosure is powered by the battery 22 to a circuit board, the circuit board controls the motor 231 to run, the motor 231 drives the worm wheel 241 and the transmission gear 242 to rotate through the worm 232, and then drives the kneading shaft 251 to rotate through the driven gear 252, and the kneading shaft 251 passes through the first shaft hole 262 and is mounted inside the second shaft hole 274 and drives the eccentric swing wheel 27 to rotate. Since the second shaft hole 274 and the eccentric shaft 271 are eccentric, and the push rod 3 is connected to the eccentric shaft 271, when the kneading shaft 251 rotates, the eccentric swing wheel 27 will drive the push rods 3 to act up and down under the eccentric action to perform shoulder massage; since the eccentric swing wheel 27 is provided with the eccentric swing inclined plane 272, and the kneading swing arms 28 is connected to the eccentric swing shaft 273, when the eccentric swing wheels 27 rotate with the kneading shaft 251, the kneading swing arms 28 drive the mounting seats 281 and then drive the massage heads 4 to rotatably act under the action of the eccentric swing inclined planes 272 to perform neck massage.

The two eccentric swing wheels 27 are jointly driven by the kneading shaft 251 to rotate, so that there is no need to install a plurality of motors 231, and there is no need to arrange worms 232 at two ends of the motors 231 to separately control the massage heads 4 and the push rods 3, thereby occupying less space inside the housing and being compact in structure.

The housing 1 includes an upper cover 11, a middle cover 12 and a lower cover 13, wherein the upper cover 11 covers the middle cover 12, and the lower cover 13 is detachably mounted to the middle cover 12; the center plate 21 and the battery 22 are arranged between the middle cover 12 and the lower cover 13 and is mounted to the middle cover 12, the motor 231, the worm wheel 241, the transmission gear 242, the kneading shaft 251, the glands 26, the eccentric swing wheels 27 and the kneading swing arms 28 are all arranged between the upper cover 11 and the middle cover 12, and the mounting seats 281 and the swing arms 33 penetrate through the upper cover 11.

In this embodiment, the battery 22 is mounted to the middle cover 12 by means of a battery pressing sheet 9.

Specifically, the side of the lower cover 13 close to the middle cover 12 is provided with a plurality of male buckles 131, and the middle cover 12 is provided with a plurality of buckle holes 123 corresponding to the male buckles 131, and the male buckle 131 is snap-fitted in the buckle hole 123.

During assembly, the lower cover 13 may be mounted by aligning the lower cover 13 with the middle cover 12 and pressing the lower cover 13 with a force, and the lower cover 13 may be detached by prying open the junction between the lower cover 13 and the middle cover 12. The lower cover 13 may be easily mounted and detached simply by the snap-fitting of the male buckles 131 and the buckle holes 123.

In order to more stably mount the lower cover 13 and the middle cover 12, in this embodiment, the side of the lower cover 13 close to the middle cover 12 is further provided with a plurality of buckling plates 132, and the middle cover 12 is provided with a plurality of buckling grooves 124 corresponding to the buckling plates 132, and when the lower cover 13 is mounted, the buckling plates 132 and the buckling grooves 124 are snap-fitted.

The above massager further includes a push rod pulling sheet 51 and a positioning post 52, and in this embodiment, the middle of the push rod 3 is also provided with a pivot hole 32; the push rod pulling sheet 51 is a strip-shaped piece with openings at two ends, a push rod rotating shaft 53 passes through the pivot hole 32 and the opening at one end of the push rod pulling sheet 51 to pivot one end of the push rod pulling sheet 51 to the pivot hole 32, and the positioning post 52 passes through the opening at the other end of the push rod pulling sheet 51 and is snap-fitted into the positioning seat 125 to pivot the push rod pulling sheet 51 to the middle cover 12, so that the push rod 3 can be hinged to the middle cover 12 to move up and down.

The bottom of the kneading swing arm 28 is provided with a guide block 283, and the middle cover 12 is provided with a guide groove 121 in which the guide block 283 can move. The guide groove 121 may be directly formed on the middle cover 12. In this embodiment, the guide groove 121 is a separately produced part, and the guide groove 121 is detachably mounted on the middle cover 12. When the kneading swing arm 28 moves, the guide block 283 is arranged in the guide groove 121 in a clearance fit manner.

In this embodiment, the machine core box includes a box upper cover 61 and a box lower cover 62, wherein the iron shaft 243 and the motor 231 are both mounted to the box lower cover 62, one end of the worm 232 is connected to the motor 231, and the other end of the worm 232 is fixed to the box lower cover 62; the box upper cover 61 covers the kneading shaft 251 and is mounted to the box lower cover 62, and the box lower cover 62 is mounted to the housing 1. The box upper cover 61 and the box lower cover 62 stably mount the motor 231, the worm 232, the iron shaft 243, and the kneading shaft 251 in the housing 1.

In order to stably assemble the driving assembly 2, the embodiment further includes two fixing rings 71, the fixing ring 71 is mounted on the outer side of the blocking piece 29, the middle cover 12 is provided with two fixing seats 122 for mounting the fixing rings 71, and the fixing ring 71 is detachably mounted to the fixing seat 122; the eccentric swing wheel 27 is provided with a third shaft hole 279 in the connecting seat 276 and corresponding to the fixing ring 71, a lock post (not shown) passes through the blocking piece 29 and the third shaft hole 279 and is mounted to the fixing ring 71, and the kneading swing arm 28 and the eccentric swing wheel 27 are mounted to the middle cover 12 by enabling the lock post to pass through the third shaft hole 279 and the fixing ring 71.

In this embodiment, the kneading shaft 251 is further sleeved with bearings 72 on two sides of the driven gear 252, the bearing 72 is arranged between the gland 26 and the driven gear 252, and the bearing 72 is mounted between the box upper cover 61 and the box lower cover 62.

The inner wall of the connecting hole 31 of the push rod 3 is provided with a first countersink 311, and when the connecting piece 261 is placed in the connecting hole 31, the baffle 264 of the gland 26 abuts against the first countersink 311. The inner wall of the through hole 282 of the kneading swing arm 28 is provided with a second countersink 284, and when the eccentric swing shaft 273 is placed in the through hole 282, the eccentric swing inclined plane 272 abuts against the second countersink 284.

In this embodiment, the baffle 264 of the gland 26 is provided with a plurality of first oil storage holes 265, the eccentric swing wheel 27 is provided with a plurality of second oil storage holes 275, the through hole 282 of the kneading swing arm 28 is provided with a plurality of second oil storage grooves 285, and the connecting hole 31 of the push rod 3 is provided with a plurality of first oil storage grooves 312. After the first oil storage holes 265, the second oil storage holes 275, the first oil storage grooves 312 and the second oil storage grooves 285 are filled with lubricating oil, the glands 26, the push rods 3, the eccentric swing wheels 27 and the kneading swing arms 28 can form oil film contact during operation of the driving assembly of the present disclosure, thus reducing the friction resistance and power loss, and also reducing the wear among lubricated components and prolonging the service life of the components.

In this embodiment, the upper cover 11 is provided with a first mounting hole in which the mounting seat 281 can move and at a position corresponding to the mounting seat 281, the first mounting hole is provided with a first buffer sleeve 111, and one end of the mounting seat 281 passes through the middle of the first buffer sleeve 111 and is connected with the massage head 4; the upper cover 11 is provided with a second mounting hole in which the push rod 3 can move and at a position corresponding to the push rod 3, the second mounting hole is provided with a second buffer sleeve 112, the second buffer sleeve 112 is mounted to the upper cover 11 by means of a silicone pressing sheet 113, and one end of the push rod 3 passes out of the upper cover 11 from the middle of the second buffer sleeve 112. By arranging the first buffer sleeve 111 and the second buffer sleeve 112, buffer can be provided when the massage heads 4 and the push rods 3 perform massage, so as to prevent the mounting seats 281 and the push rods 3 from rubbing against the upper cover 11, and also play a dust-proof role.

In this embodiment, a controller is integrated on the shoulder strap 8, and the controller is connected with the center plate 21, thereby controlling the working state of the massager.

In order to more firmly mount the shoulder straps 8 and prevent the shoulder straps 8 from being deformed by tensions, the parts of the shoulder straps 8 close to the middle cover 12 are covered with mounting sheets 81 made of hard material (e.g., hard plastic, metal, etc.), respectively, and the two mounting sheets 81 are locked to two sides of the middle cover 12 by screws, respectively.

In addition, since the lower cover 13 is detachably mounted to the middle cover 12 through the mutually matched male buckles 131 and buckle holes 123, the lower cover 13 protects the center plate 21 and the battery 22 and also covers the mounting sheets 81, thereby preventing the mounting sheets 81 and screw holes from being exposed, so that the whole massager is more aesthetically pleasing; when the shoulder strap 8 is detached, the mounting sheet 81 can be detached by prying off the lower cover 13, which is convenient to operate.

The massage head 4 used in this embodiment includes a massage sleeve 41, a fixing piece 42 and a base 43, wherein the base 43 is detachably mounted to the mounting seat 281, the fixing piece 42 is locked to the base 43 by screws, and the massage sleeve 41 sleeves the fixing piece 42.

The above-mentioned massage sleeve 41 is a hollow hemispherical soft rubber sleeve, the fixing piece 42 is a hollow seat, and a cavity is defined by the massage sleeve 41, the fixing piece 42 and the base 43, so that the massage head 4 is more elastic in the massage process and can provide a more comfortable massage experience. The massage sleeve 41 may also be made of other elastic flexible materials.

Specifically, according to the massager of the present disclosure, different massage heads 4 may be replaced according to different massage parts, and a solid massage head 4 or the like may be used.

In this embodiment, the lower cover 13 is further provided with a decorative piece 14, and the decorative piece 14 is detachably mounted to the middle of the lower cover 13 to make the overall appearance of the massager more aesthetically pleasing.

While the principles and embodiments of the present disclosure have been described herein with reference to specific examples, the description of the embodiments is intended to aid in understanding the method and its core concept; in the meantime, it will be apparent to those skilled in the art that various changes may be made in the specific embodiments and the scope of the application according to the teachings of the present disclosure. In conclusion, the present description should not be construed as limiting the present disclosure.

What is claimed is:

1. A neck and shoulder massager, comprising: a housing, a machine core box, a driving assembly, a push rod, a mounting seat, a massage head, and two shoulder straps, wherein
the push rod is connected to the driving assembly and the housing and is limited by the housing, and the push rod partially protrudes from the housing and swings up and down;
the mounting seat is connected to the driving assembly and penetrates through the housing, and the massage head is detachably mounted to the mounting seat, and rotatably swings with the mounting seat;
the driving assembly is mounted to the machine core box, and drives the push rod and the massage head to act;
the machine core box is arranged in the housing;
the two shoulder straps are detachably mounted to two sides of the housing, respectively, and the shoulder strap is formed by a hot pressing process.

2. The neck and shoulder massager according to claim 1, wherein the housing comprises an upper cover, a middle cover and a lower cover, wherein the upper cover and the lower cover are detachably mounted together, the middle cover is arranged in a space defined by the upper cover and the lower cover, the driving assembly is mounted on the middle cover, one end of the mounting seat is connected with the driving assembly, the other end of the mounting seat extends to the upper cover and is detachably connected with the massage head, one end of the push rod is connected with the driving assembly, and the other end of the push rod protrudes from the upper cover.

3. The neck and shoulder massager according to claim 2, wherein the upper cover is provided with a first buffer sleeve corresponding to the mounting seat, and the first buffer sleeve sleeves the mounting seat; the upper cover is provided with a second buffer sleeve corresponding to the push rod, and the second buffer sleeve sleeves the push rod.

4. The neck and shoulder massager according to claim 1, wherein the two shoulder straps are respectively covered with mounting sheets at sides close to the housing, and the two shoulder straps are fixedly connected to two sides of the housing by the mounting sheets.

5. The neck and shoulder massager according to claim 1, wherein the massage head comprises a massage sleeve, a fixing piece and a base, wherein the base is detachably mounted to the mounting seat, the fixing piece is mounted to the base, and the massage sleeve sleeves the fixing piece.

6. The neck and shoulder massager according to claim 5, wherein the massage sleeve is a hollow hemispherical soft rubber sleeve, the fixing piece is a hollow seat, and a cavity is defined by the massage sleeve, the fixing piece and the base.

7. The neck and shoulder massager according to claim 2, wherein the lower cover and the middle cover are detachably connected by means of mutually matched male buckles and buckle holes.

8. The neck and shoulder massager according to claim 2, wherein the driving assembly comprises a center plate, a battery, a motor, a worm wheel, a transmission gear, a kneading shaft, a gland, an eccentric swing wheel, a kneading swing arm and a blocking piece, wherein the battery and the motor are both connected to the center plate, the motor is provided with a worm, and the worm is perpendicular to the kneading shaft;
the worm wheel and the transmission gear are coaxially mounted to the housing through an iron shaft, a middle of the kneading shaft is provided with a driven gear, the iron shaft is parallel to the kneading shaft, the driven gear is engaged with the transmission gear, and the worm wheel is engaged with the worm;
two glands are arranged on the kneading shaft by fixed transition connection with the eccentric swing wheels, two push rods are correspondingly arranged on one sides of the two eccentric swing wheels and are fixed and radially limited by the glands, and two kneading swing arms are correspondingly arranged on the other sides of the two eccentric swing wheels and are fixed and radially limited by the blocking pieces;
the gland is provided with a first shaft hole corresponding to the kneading shaft, and the kneading shaft passes through the first shaft hole; a side of the gland facing the push rod is provided with a connecting piece extending to the eccentric swing wheel;
the eccentric swing wheel is provided with a connecting groove corresponding to the connecting piece, a side of the eccentric swing wheel close to the gland is provided with an eccentric shaft, and the eccentric shaft is sleeved with the connecting hole; a side of the eccentric swing wheel close to the kneading swing arm is provided with an eccentric swing inclined plane and an eccentric swing shaft, the eccentric swing inclined plane is arranged between the eccentric shaft and the eccentric swing shaft; the eccentric swing wheel is provided with a second shaft hole corresponding to the first shaft hole, the second shaft hole and the eccentric shaft are eccentric, and the kneading shaft passes through the first shaft hole and is mounted inside the second shaft hole;
the push rod comprises a connecting hole and a swing arm, the connecting hole sleeves the eccentric shaft at one end of the eccentric swing wheel, and a top end of the swing arm penetrates through the housing;
the mounting seat is formed at the top of the kneading swing arm, the kneading swing arm is provided with a through hole corresponding to the eccentric swing shaft, the through hole sleeves the eccentric swing shaft, and the kneading swing arm is obliquely arranged relative to the kneading shaft.

9. The neck and shoulder massager according to claim 8, wherein the machine core box comprises a box upper cover and a box lower cover, wherein the iron shaft and the motor are both mounted to the box lower cover, one end of the worm is connected to the motor, and the other end of the worm is fixed to the box lower cover; the box upper cover covers the kneading shaft and is mounted to the box lower cover, and the box lower cover is mounted to the housing.

10. The neck and shoulder massager according to claim 8, further comprising a guide groove, wherein the guide groove is detachably mounted to the housing, a bottom of the kneading swing arm is provided with a guide block, and the guide block is arranged in the guide groove in a clearance fit manner.
